(19) United States
(12) Patent Application Publication
(10) Pub. No.: US 2004/0244275 A1
(43) Pub. Date: Dec. 9, 2004

(54) Method and apparatus for repelling flying insects

(75) Inventors: Robert W. Forsberg, Mequon, WI (US); Charles P. Croft, Greenwood, FL (US)

Correspondence Address: RYAN KROMHOLZ & MANION, S.C., POST OFFICE BOX 26618, MILWAUKEE, WI, 53226, US

(73) Assignee: Forsberg Packaging Co., LLC

(21) Appl. No.: 10/455,782

(22) Filed: Jun. 5, 2003

(51) Int. Cl. A01M 1/20

(52) U.S. Cl. 43/132.1

(57) ABSTRACT

A method and apparatus for repelling insects from agricultural plantings including a reflective material. The reflective material having an extremely thin, metallizing applied thereto.

### BACKGROUND OF THE INVENTION

This invention relates to plant protection and more specifically to plant protection from flying insects.

Farmers have battled insects attacking their crops and plants since the beginning of time. A generally accepted method of protecting plants is to locate the plants within an enclosed area, such as a greenhouse. However, enclosed areas are often not practical for large crops and can be expensive to design and maintain. Likewise, flying insects may still enter an enclosure when a person enters or leaves the enclosure to tend to the plants.

Another method of repelling insects from the plants is to apply a chemical or pesticide to the plants to keep away insects. However, such chemicals can be costly and destructive to the environment. Thus, an environmentally friendly, inexpensive alternative is needed for plant protection.

### SUMMARY OF THE INVENTION

The present invention provides a simple arrangement for protection of plants, such as tomato or tobacco plants, from flying insects, such as thrips, white flies, and the like. The invention consists of a thin reflective ribbon or tape of material attached to an elongated upright, such as a pole or stake, which is located proximate the plant or plants to be protected.

The reflective ribbon or tape of material may be freely suspended from the upright, approximately at the height of the plants or several inches above the plant height, or alternatively, may be placed in a continuous form between multiple uprights. In this manner, the reflective material shines light back to the plants and surrounding area, which is believed to disorient the flying insects. In doing so, the disoriented insects do not land on the plants having the reflective ribbon located near them, and the plants are thereby protected from flying insects.

### BRIEF DESCRIPTION OF THE DRAWINGS

FIG. 1 is a perspective view of a wound reel of reflective ribbon as shipped to a user, and in accordance with the present invention. This provides an initial step in the method of utilizing the invented concept.

FIG. 2 is a perspective view of an individual ribbon cut to a predetermined length, or otherwise removed, from the reel of FIG. 1.

FIG. 2A is a perspective view of an alternative ribbon arrangement, seen as having a relatively wide length and transverse slits made therein.

FIG. 3 is a perspective view of an upright in the form of an elongated stake with an attached reflective ribbon, according to this invention. The ribbon includes a centralized proximal portion attached to the upper end of the stake and further including oppositely extending, freely suspended, distal end portions.

FIG. 4 is a perspective view illustrative of a row of plantings and including a plurality of laterally spaced stakes extending from the ground in the proximity of each plant and including attached reflective ribbon.

FIG. 5 is a top plan view of a plurality of plants and nearby stakes with attached reflective ribbons for protecting the plants, and showing, in particular, plants with the ribbons extended laterally relative to the plants and in position for repelling nearby flying insects.

FIG. 6 is a perspective view illustrating an alternative arrangement of reflective ribbon wherein the ribbon is strung in a continuous fashion between a plurality of laterally spaced uprights in the form of stakes.

FIG. 7 is a perspective view similar to that of FIG. 6, but showing an alternative, fringed ribbon.

### DESCRIPTION OF THE PREFERRED EMBODIMENT

Although the disclosure hereof is detailed and exact to enable those skilled in the art to practice the invention, the physical embodiments herein disclosed merely exemplify the invention, which may be embodied in other specific structure. While the preferred embodiment has been described, the details may be changed without departing from the invention, which is defined by the claims.

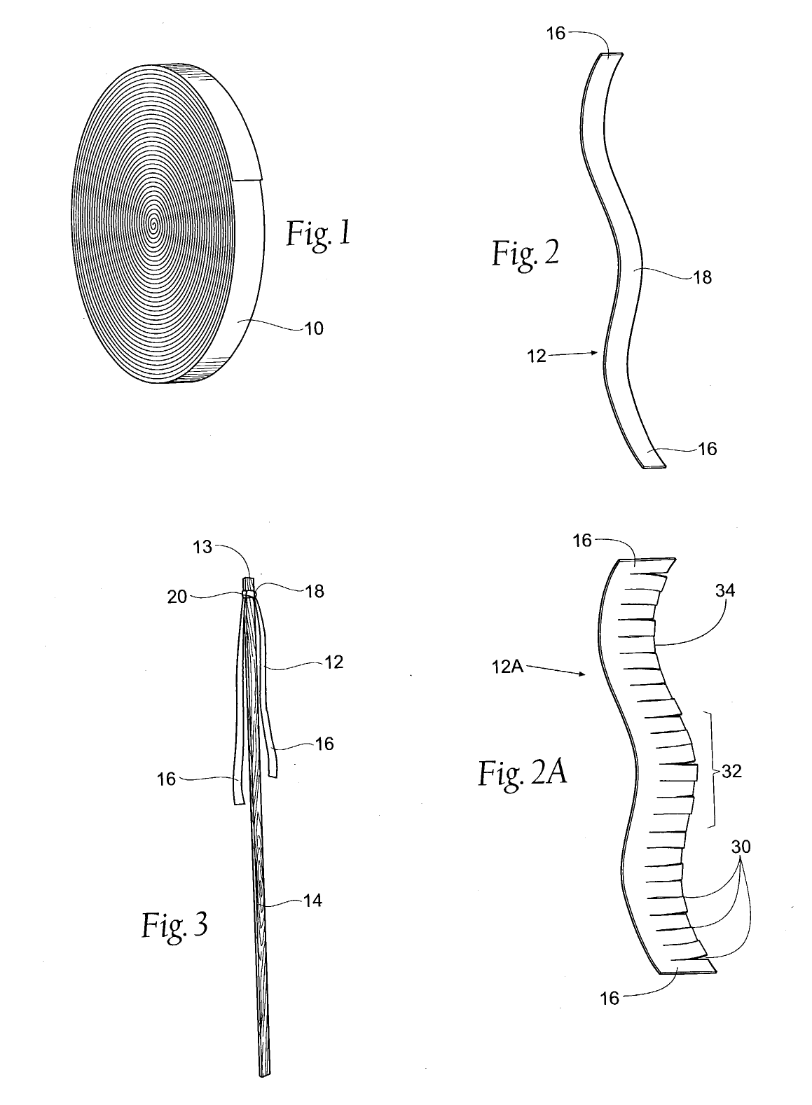

With reference to FIG. 1, there is shown a perspective view of a ribbon reel 10 of the present invention. Individual ribbons, such as that identified by the numeral 12 in the view of FIG. 2, may be cut to a desired length from the reel 10. One embodiment of a ribbon 12 in accordance with the present invention, and as seen in FIG. 2, preferably includes oppositely disposed distal end portions 16 and a centralized section or proximal portion 18. Alternatively, and with reference to FIG. 2A, a preferred ribbon 12A may be cut from reels of relatively greater width and be further supplied with a plurality of longitudinally spaced, transverse slits 30 to thereby provide the alternative ribbon 12A with a fringed portion 32. The fringed portion 32 may be provided along one marginal longitudinal edge 34, as shown, or may be provided along more than one marginal edge 34 (not shown). Additionally, the fringed portion 32 may be provided along a portion of a selected marginal edge 34.

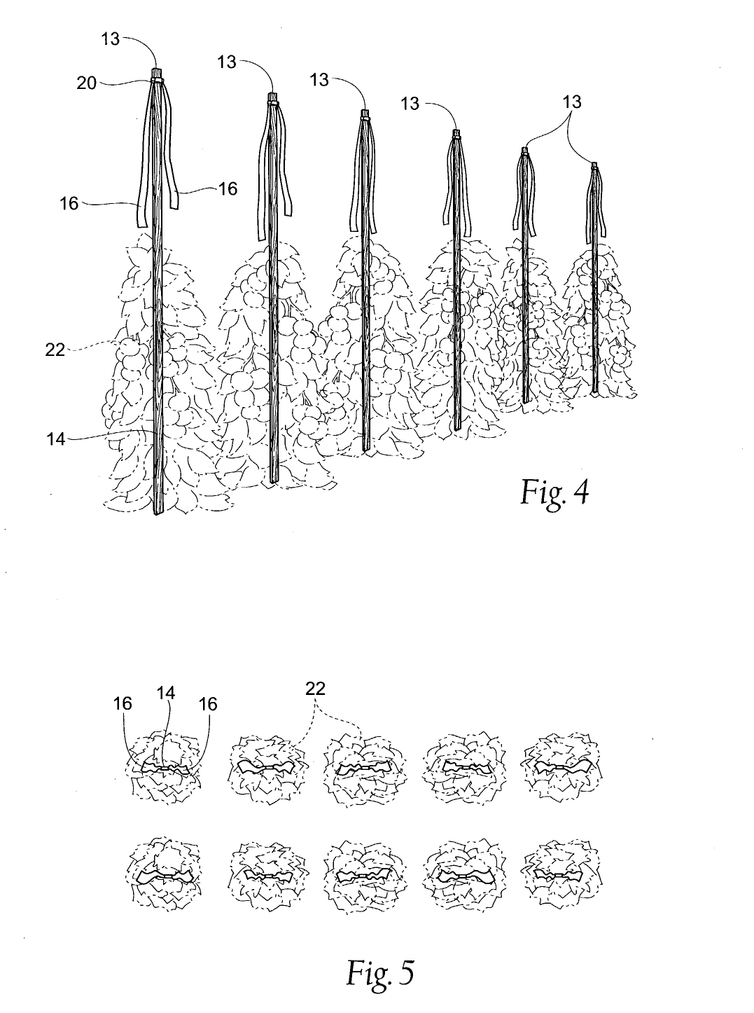

With reference to FIG. 3, a preferred embodiment of the invention may be seen in the form of an upright, such as the stake 14 shown, having a reflective ribbon 12 according to the present invention affixed thereto. The upright or stake 14 with attached ribbon 12 is preferably placed proximate a predetermined plant 22 to be protected, with a series of such plantings shown in the view of FIG. 4. In the present embodiment, a centralized section or proximal portion 18 of an individual ribbon 12 is attached to the top 13 of a stake 14 by way of a fastening means such as the elastic ring 20, shown. An acceptable elastic ring 20 may be in the form of a conventional rubber band or other suitable device, such as a wood or plastic clip (not shown). It will also be apparent that the fastening means may be in the form of conventional nails, tacks, or staples (not shown). It will be further apparent that individual strips of ribbon 12 may be attached at one end 16 (rather than the centralized portion 18) of the strip with the opposite distal end 16 being freely suspended to fly outwardly responsive to a passing breeze.

FIGS. 3 and 4 illustrate distal end portions 16 of ribbon 12 shown in a collapsed position, in ready position for a relatively low velocity, passing breeze. Thus, when subjected to a slight breeze, the unrestricted, freely suspended distal portions 16 will be moved with the breeze, somewhat similar to that shown in FIG. 5. The distal portions 16 reflect light during movement by a breeze, or at rest, thereby keeping flying insects, especially thrips and white flies (not shown), in the case of tomato plants, away from the plant or plants 22.

In general, the length of the upright or stake 14 shown, is determined by the circumstances of the localized planting area, and is typically preferred to be of approximately the same elevation, or an inch or more higher than, the height of the plant 22 to be protected. It is also contemplated that the upright 14 may be designed so that other arrangements may fall within the definition of an upright. As an example, two laterally spaced stakes 14 may be located at a respective end of a row with a supporting wire (not shown) extending between the stakes 14. It is to be understood that an upright 14 according to the present invention may include any device that will allow a ribbon of material 12 to be suspended proximate to the plant 22.

The effective reflective ribbon 12 material is preferably fabricated from a 70-gauge, polypropylene film, having an extremely thin, vapor-deposited, or sputter process metallic reflective coating applied thereto. Films of various thickness and width may be used according to the ultimate desired location, plant to be protected, and insect situation. However, it is to be noted that ribbon 12 made from a material thinner than the preferred 70-gage material is less durable, while ribbon 12 made from a thicker material is more cost prohibitive, less pliable, and less reactive to air currents. Other film types, such as polyester, polyethylene, and vinyl, have also proved to be effective. The choice of dimension of the ribbon material 12 may vary by location, type of insect, and the plant affected by the insect. However, the ribbon 12 appears to function, and to be manufactured best, at a width of approximately 2 inches. The length of the ribbon 12 is discretionary depending upon the user's needs, however a ribbon with a freely suspended distal portion or portions 16 of approximately 8 inches to 16 inches has been found to be of effective length.

With regard to location of the suspended ribbons 12 relative to a preselected plant 22, placement proximate to the plant 22 has been found to be acceptable. When plants 22 are arranged in rows, such as in a conventional series of adjacent rows in parallel relationship, it is preferred that the ribbons 12 be located in each row of planted rows of vegetation 22, as seen in FIG. 5.

It is of interest to note, however, that in one experiment, stakes 14 with attached, suspended ribbons 12 have been located in outer rows defining a rectangularly planted field. Also, experimentally, wherein there are several parallel, adjacent, rows of straight plantings, stakes have been placed in alternate rows of these parallel rows. It was noted from the experiment, that in each of the mentioned arrangements, the insects flew toward the areas in which there were no ribbons 12. Thus, it is preferred to place the uprights 14 and their respective ribbons 12 of material in every row of a field, as shown in FIG. 5.

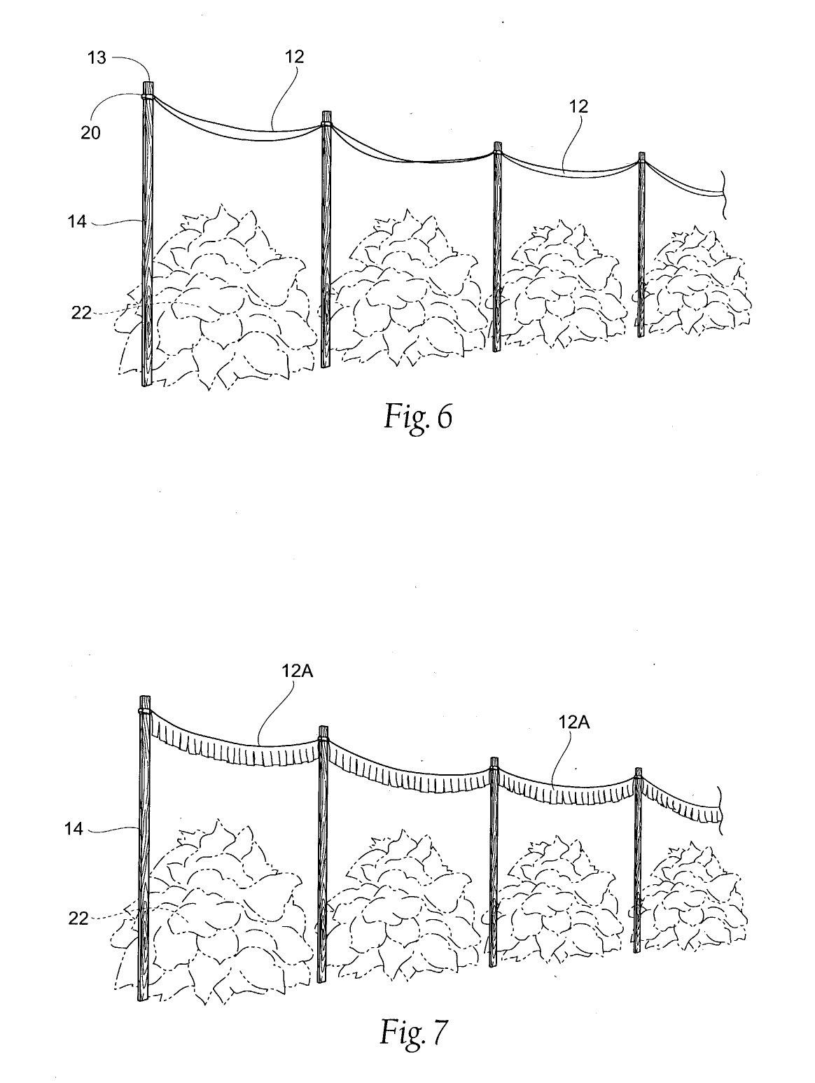

An alternative ribbon arrangement may be seen in the view of FIG. 6. In this view, the reflective ribbon 12 is shown placed in a continuous form between spaced apart stakes 14. In this configuration, the reflective ribbon is preferably spaced to provide some slack between the stakes 14 to thereby allow free movement of the ribbon 12 with air currents. Alternatively the arrangement shown in FIG. 6 may be accomplished utilizing ribbon 12A having a fringed portion 32, as shown in FIG. 7.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is herein defined by the claims.

1. A method for repelling flying insects from an agricultural planting, said method comprising:
providing at least one elongated upright of predetermined height;
positioning said upright proximate to said agriculture planting;
providing an elongated shiny reflective ribbon of material, said ribbon having a predetermined length and a preselected width, and wherein ribbon of material further includes a distal portion and a proximal portion; and
fastening said proximal portion of said ribbon of material to said upright to permit said distal portion of said ribbon of material to be freely suspended.

2. The method according to claim 1 wherein said upright is an elongated stake inserted into earth proximate said agricultural planting.

3. The method of claim 2, wherein said agricultural planting is arranged as a row of plantings.

4. The method of claim 3, further including the steps of:
providing a plurality of elongated stakes; and
spacing said stakes laterally along said row of plantings.

5. The method of claim 2 wherein said agricultural planting is arranged as a series of adjacent rows of plantings in parallel relationship.

6. The method of claim 5 further including the steps of:
providing a plurality of elongated stakes; and
spacing said stakes laterally along each of said adjacent rows of plantings.

7. An apparatus for repelling flying insects from vegetation, said apparatus comprising:
an elongated upright including a predetermined elevation relative to said vegetation; and
a ribbon of shiny reflective film material suspended from said upright proximate to said predetermined elevation.

8. The apparatus of claim 7 wherein one marginal longitudinal edge of said ribbon is provided with at least a portion thereof defined by a plurality of longitudinally spaced, transverse slits.

9. The apparatus according to claim 7 wherein said ribbon of film material further comprises:
a proximate portion fastened to said elongated upright, and
a distal portion being freely suspended with respect to said upright.

10. The apparatus according to claim 7 wherein said ribbon of material comprises a polypropylene film backing material with a vapor-deposited, metallic reflective coating deposited thereon.

11. The apparatus according to claim 7 wherein said ribbon of material comprises a polypropylene film backing material with a sputter process metallic reflective coating deposited thereon.

12. A method for repelling flying insects from an agricultural planting, said method comprising:
providing at least two elongated uprights of predetermined height;
positioning said uprights proximate to said agriculture planting;
providing an elongated shiny reflective ribbon of material, said ribbon having a predetermined length, a preselected width and two oppositely disposed distal end portions; and
fastening one of said distal end portions of said ribbon of material to one of said uprights, and fastening another of said distal ends to a second of said uprights, and being of such length to permit said ribbon of material to be freely suspended.

13. The method of claim 12 further including the step of providing said elongated ribbon with at least one marginal edge, said marginal edge provided with at least a portion thereof defined by a plurality of longitudinally spaced transverse slits.

14. A non-mechanized, non-electrical method for repelling flying insects from an agricultural planting, said method comprising:
providing at least one elongated upright of predetermined height;
positioning said upright proximate to said agriculture planting;
providing an elongated shiny reflective ribbon of material, said ribbon having a predetermined length and a preselected width, and wherein said ribbon of material further includes a distal portion and a proximal portion; and
fastening said proximal portion of said ribbon of material to said upright to permit said distal portion of said ribbon of material to be freely suspended.
